(19) United States
(12) Patent Application Publication
(10) Pub. No.: US 2004/0129342 A1
(43) Pub. Date: Jul. 8, 2004

(54) Method and apparatus for dispensing a beverage

(76) Inventors: Iain W. Anderson, Staffordshire (GB); Wendy G. Box, Staffordshire (GB); Peter T. Foster, Staffordshire (GB); Rachel J. Galt, Staffordshire (GB); Stuart W. Molzahn, Derbyshire (GB); David E. Quain, Staffordshire (GB); Stephen P. Smith, Derbyshire (GB); Alan R. Wright, Derbyshire (GB)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/338,315

(22) Filed: Jan. 8, 2003

(51) Int. Cl. B67C 3/26

(52) U.S. Cl. 141/268

(57) ABSTRACT

A method of dispensing draught beverage comprises delivering draught beverage (which may be alcoholic, for example lager) from a nozzle 2 into a drinking glass 5 which is being rotated by a rotatably driven platform 8. The nozzle 2 and platform can be part of a font or beverage dispensing apparatus at a drinks bar. In the vicinity of the rotating glass is a rotating visual display which is provided by a cylinder 9 which rotates with the platform and bears a succession of cinematographic representations or pictures 10 which move within an enclosure 6 having a viewing window 4 through which the moving representations are viewed as an animated display.

### FIELD OF THE INVENTION

This invention concerns dispensing draught beverage and also apparatus for dispensing draught beverage.

### BACKGROUND TO THE INVENTION

The sale of beverages, for example in bars, generally entails a customer coming to a bar counter and ordering the beverage, which is dispensed at the bar from a font. The font is generally functional in nature although it may also be designed to be visually attractive and to convey some form of information to the customer.

### SUMMARY OF THE INVENTION

The present invention aims to provide a method of, and apparatus for, dispensing draught beverage which makes the process of dispense more interesting and enjoyable.

According to a first aspect of the invention there is provided a method of dispensing a beverage comprising providing a vessel, rotating the vessel, delivering beverage into the vessel at a point of dispense, and in response to dispense of the beverage, providing a visual display in the vicinity of the point of dispense.

Preferably the display is a moving display. For example the visual display may be a rotating display. More preferably the vessel is rotated while the beverage is being dispensed.

Preferably the beverage is dispensed in a dispense cycle and the visual display is started at a predetermined point in the dispense cycle. The visual display may last a predetermined time, or end at a predetermined time in the dispense cycle.

Preferably the method includes producing at least one moving beam of light to provide the visual display. This can be achieved by the method including providing a light source having at least one moving part, projecting the beams of light from the moving part, and moving the moving part so as to provide the display. Said moving part may be arranged to emit the beams of light. Alternatively the source may be arranged to produce light and said moving part reflects the light to form the beams. Alternatively the source may be arranged to produce light and the moving part comprise an obstacle past which at least some of the light is projected to form the beams. For example the obstacle may define an aperture through which some of the light passes to form the beams.

In an alternative arrangement said moving part comprises a moving member having a surface at least partly formed from a plurality of mirrors which produce a plurality of said light beams by reflection, such a mirror ball.

Preferably the vessel is rotated on a rotating support and said moving part is rotated by rotation of the support. The moving part may form part of the support, or be mounted on it. For example the support may have a surface on which the vessel is supported, and the moving part be situated on the surface so that the beams of light are transmitted through the vessel. Alternatively the moving part may be mounted on the support at a position to one side of the vessel.

The moving part may be provided on a collar surrounding the vessel. In this case the collar is preferably rotated as the beverage is dispensed.

Preferably the at least one beam of light is projected to provide the display, for example onto a surface which may be a screen specifically provided for the purpose, or may be a wall or ceiling of a room in which the apparatus is located.

The method may further include providing a rotatable member associated with the rotating vessel, the member bearing a succession of cinematographic representations and rotating the rotatable member to provide the visual display as an animated display.

Preferably the beverage is alcoholic, for example being selected from the group consisting of beer and cider.

Preferably the method comprises providing an enclosure having a window therethrough, and a rotatable member within the enclosure which has representations thereon, and rotating the rotatable member within the enclosure such that the representations are visible through the window to provide the visual display.

Preferably the display is controlled by a controller which also controls dispense of the beverage. The visual display may conveniently be provided on a video screen.

The present invention still further provides apparatus for dispensing a beverage and providing a visual display, the apparatus comprising a support for a vessel, a dispense nozzle arranged to dispense beverage into the vessel, and a display arranged to provide a visual display in the vicinity of the rotating vessel in response to dispense of the beverage.

Preferably the apparatus is arranged to dispense the beverage in a dispense cycle and to the start the visual display at a predetermined point in the dispense cycle. The visual display may be arranged to last a predetermined time, or to end at a predetermined time in the dispense cycle.

Preferably the display is arranged to produce at least one beam of light to provide the visual display. Conveniently the apparatus may include a light source having at least one moving part, the moving part being arranged to project the beam of light so as to provide the display. Said moving part may be arranged to emit the beam of light. Alternatively the source may be arranged to produce light and said moving part be arranged to reflect the light to form the beam. As a further alternative the source may be arranged to produce light and the moving part comprise an obstacle past which at least some of the light can be projected to form the beams. Preferable the obstacle defines an aperture through which some of the light can pass to form the beams. Said moving part may comprise a moving member, such as a mirror ball having a surface at least partly formed from a plurality of mirrors which produce a plurality of said light beams by reflection. Preferably said moving part is arranged to be rotated by rotation of the support.

The apparatus may include a rotatable member associated with the support, the member bearing a succession of cinematographic representations and being rotatable to provide said visual display as an animated display. Furthermore the apparatus may further comprise an enclosure surrounding the rotatable member and having a window therein through which the representations can be viewed.

Preferably the apparatus further comprises control means arranged to control dispense of the beverage and the display.

Preferably the apparatus is arranged to be able to dispense any of a plurality of beverages, and to display any of a plurality of visual displays, and the visual display selected depends on the beverage selected.

The draught beverage may be cooled prior to delivery into the vessel, for example using beverage cooling means in a beverage dispensing system which may convey beverage from a supply of beverage to the nozzle, which may be in a font, at, for example a drinks bar.

Attention is drawn to two International patent applications, namely International Application No. PCT.GB99/03824 (published under No. WO01/36582) and International application No. PCT/GB99/01551 (published under No. WO99/60092). Any individual feature or any combination of such features of any beverage disclosed in either of these international Applications, and any method or apparatus or part of any method or apparatus disclosed in either of those International Applications may be utilized in the dispense of beverage which is the subject of this current application.

The invention will now be further described, by way of example, with reference to the accompanying drawings.

### BRIEF DESCRIPTION OF THE DRAWINGS

FIG. 1 is a schematic section through apparatus according a first embodiment of the invention;

FIG. 2 is a schematic representation of apparatus according to a second embodiment of the invention;

FIG. 3 is a schematic representation of apparatus according to a third embodiment of the invention;

FIG. 4 is a schematic representation of apparatus according to a fourth embodiment of the invention;

FIG. 5 is a perspective view of apparatus according to a fifth embodiment of the invention; and

FIG. 6 shows the embodiment of FIG. 3 in use in a bar.

### DESCRIPTION OF THE PREFERRED EMBODIMENTS

With reference to FIG. 1, in a first embodiment of the invention beverage is dispensed into a glass 5 from a dispensing nozzle 2 which forms part of a font or beverage dispensing apparatus at a drinks bar.

The glass 5 is supported on a rotating platform 8 having a cylinder 9 mounted thereon to rotate with the platform. The cylinder 9 bears a number of cinematographic representations of pictures 10 viewable in succession through an opening 4 in a stationary cover or enclosure 6. A light 3 is provided in the cover 6 and is directed onto the cylinder 9 at a position which is visible through the opening 4. The light 3 flashes on each time one of the pictures 10 is centrally located opposite the opening so that the consecutively visible pictures form an animated display as the cylinder revolves.

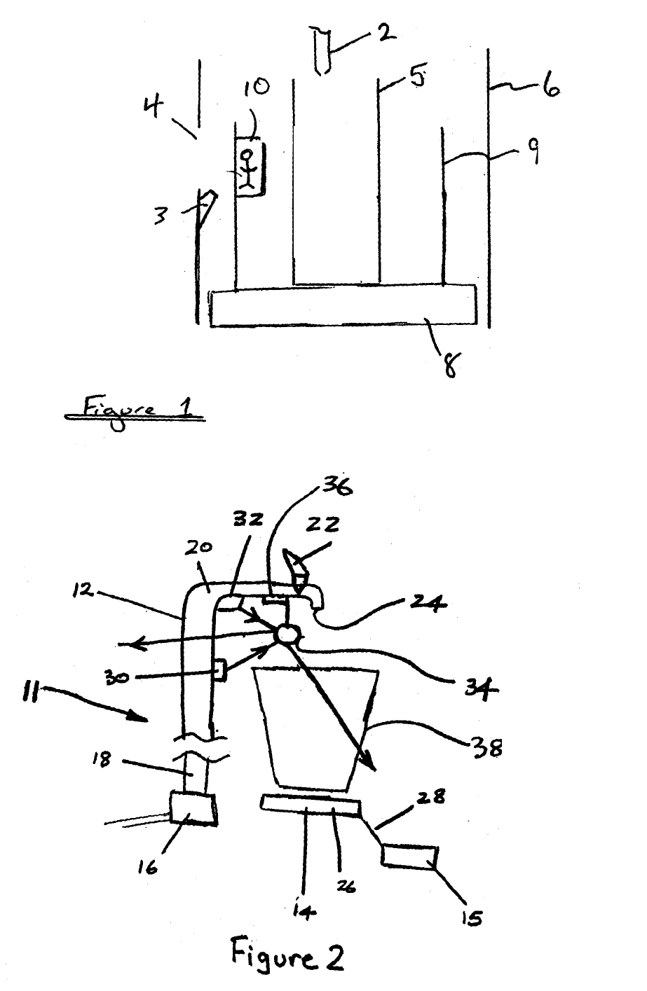

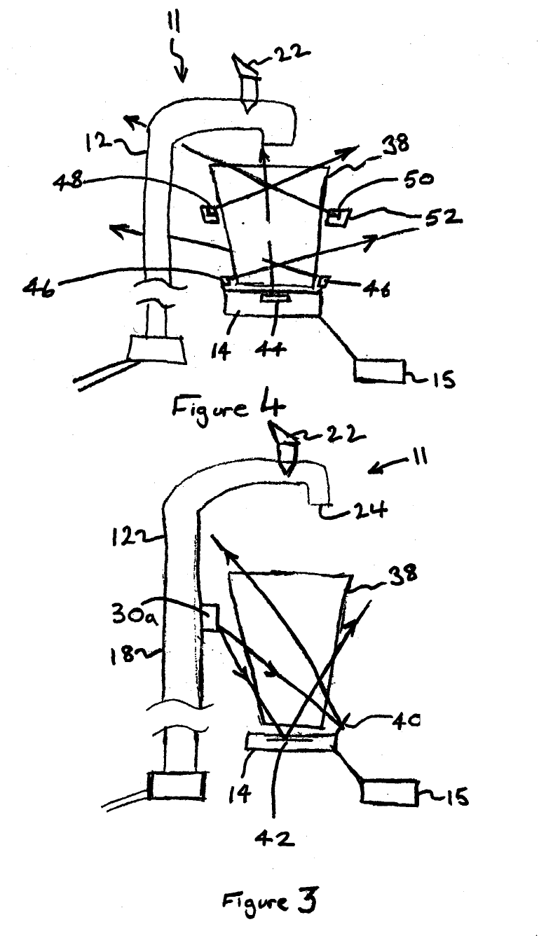

With reference to FIG. 2, in a second embodiment of the invention a beverage dispensing apparatus 11 includes a font 12, a platform 14 and a motor 15. The dispensing apparatus 11 is arranged so that it may be provided at a drinks bar, for example on the bar counter.

The font 12 has a cooling unit 16 which is mounted under the bar for cooling the beverage, an elongate stem 18 extending upwards from the bar and an arm 20, containing a valve 22, projecting perpendicularly from the upper end of the stem 18. In use, the valve 22 regulates the flow of a beverage from the cooling unit 16 to a nozzle 24 at the free end of the arm 20.

The platform 14 is in the form of a horizontal circular disc 26 which is free to rotate about its vertical central axis. The disc 26 is drivingly connected to the motor 15 by means of a belt drive 28, so as to effect the rotation of the disc 26, in use. Other driving connections, for example gearing arrangements, such as a worm gear, could also be used.

The font 12 has light sources 30, 32 in the form of light bulbs mounted respectively on the stem 18 and at the junction of the stem 18 and the arm 20. A mirror-ball 34 depends from the arm 20 and is connected to a drive unit 36 which rotates the ball 34.

In use, a beverage container or drinking vessel, typically a glass 38, is placed upon the platform 14 and the motor 15 is actuated, either manually or by means of a pressure sensor on the platform 14, causing the platform 14 to rotate.

The light bulbs 30, 32 are activated and produce light which is directed towards the mirror ball 34. The drive unit 36 is also activated causing the mirror ball to rotate. The bulbs 30, 32 and drive unit 36 can either be activated by the same actuation means as the motor 15, by another manual actuation means or alternatively by the action of opening the valve 22.

Upon the opening of the valve 22 the beverage is drawn, under pressure from a keg (not shown), through the cooling unit 16, through tubes (not shown) housed in the stem 18, along the arm 20 and exits from the nozzle 24. The beverage flows into the glass 38 as it rotates on the platform 14.

Light from the bulbs 30, 32 is directed onto the mirror-ball 34 and is reflected as a number of beams, some of which pass through the glass 38 and beverage contained in it, and some of which are directed back at the font 12. As the mirror ball 34 rotates the beams of light rotate to provide a moving visual display. A legend may be etched, stuck or printed in the glass such that it will be illuminated by the light reflected from the mirror-ball 34. Also the mirror bass itself, because it is brightly lit, will act as a rotating visual display.

The mirror ball 34 is arranged to rotate, and the bulbs 30, 32 to be lit, only while the beverage is being dispensed, and the platform 15 is arranged to rotate only while the beverage is being dispensed. This can be rotating the mirror ball 34 and platform 15 and powering the bulbs for a predetermined time from when dispense is started, or by controlling starting and stopping of the rotation and bulbs in response to operation of the tap 22.

Referring to FIG. 3 a third embodiment of the invention has a number of parts which are the same as the first embodiment and these are indicated by the same reference numerals as they are in FIG. 3. A first mirror 40 is mounted upon the platform 14 extending radially outwards and upwards so that it is inclined at an angle to the platform 14 and faces radially inwards and upwards. A second mirror 42 is mounted centrally on the platform 14. The mirrors 40, 42 are configured so as to reflect light from a light source 30a, mounted on the stem 18 of the font, through the glass 38 and the beverage as the glass is filled. The light source 30a and the motor 15 are actuated by similar actuation means as in the first embodiment.

Although shown respectively mounted upon the stem 18 and platform 14 it will be appreciated that the light source 30a and mirror 40 may be mounted in any convenient manner such that there is relative rotational movement therebetween and such that light reflected from the mirror 40 passes through the glass 38 and beverage.

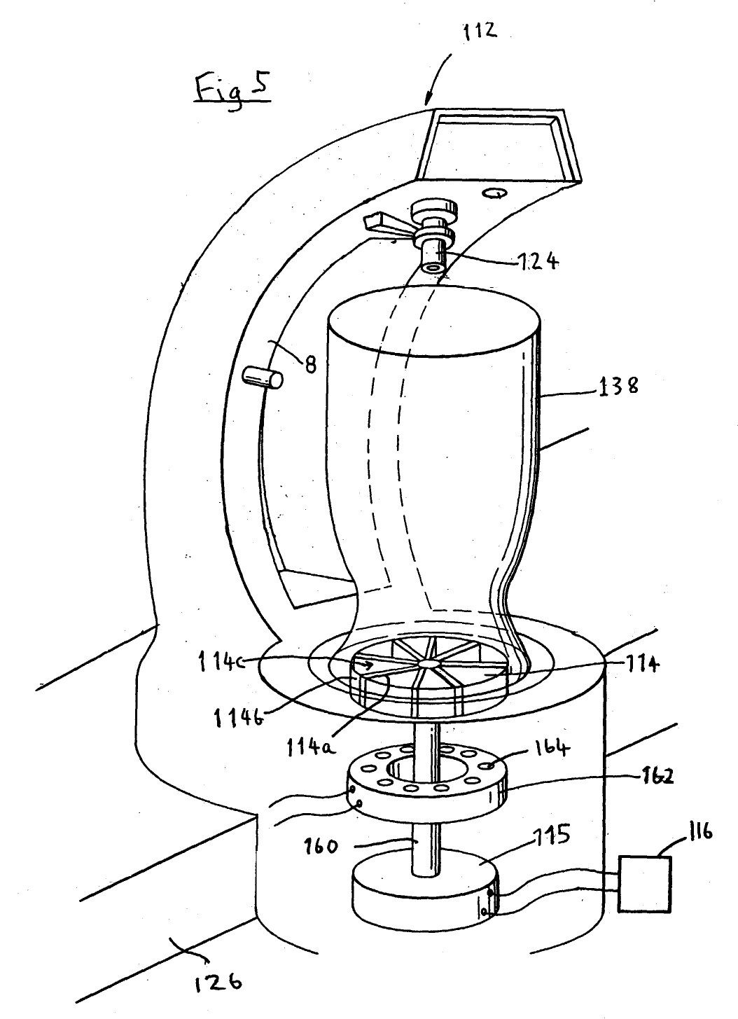

FIG. 4 shows a fourth embodiment of dispensing apparatus 11 in which light sources in the form of LEDs 44, 46 are mounted upon the platforms 14 in order to shine light through the beverage as the glass 38 is filled. One of the LEDs 44 is mounted centrally in the top surface 14a of the platform 14 so that the glass 38 rests on top of it as it is being filled with beverage. This LED 46 therefore directs light beams upwards through the base of the glass 38 and through the beverage in the glass. The other of the LEDs 46 are positioned circumferentially around the edge of the platform 14 to the side of the glass, and direct beams of light in a direction which is upwards and towards the centre of the glass.

A further set of LEDs 48, 50 are mounted on a rotating annular collar 52 through which the glass 38 is placed and which sits approximately half-way up the glass 38. The collar 52 is of a larger diameter than the glass 38 so that it is not in contact with the glass but spaced from it. Rotation of the collar 52 is effected by linking it to the platform 14, so that it will rotate at the same speed as the platform 14. As an alternative a further independent drive means (not shown) can be provided which can rotate the collar 52 at the same speed as the platform 14, or at a different speed.

As the LEDs rotate they provide a rotating display in two ways. Firstly the LEDs themselves will be clearly visible and can be seen to rotate with the platform 114. Secondly they will produce beams of light which will shine through the glass 38 and the beverage it contains and then either onto the font 12 or past it into the broader volume of the room in which the font is situated.

It will further be appreciated that fluorescent, photoluminescent or electroluminescent materials may be applied directly onto any or all of the font 12, the platform 14 or the glass 38 in order to pass light through the glass 38 as it is filled with beverage. Depending on the type of light source used the visual display may differ. If the lights source is a diffuse source, it will itself be visible and provide a rotating display. If the light source produces beams of light these can project away from the font and provide a larger scale visual display.

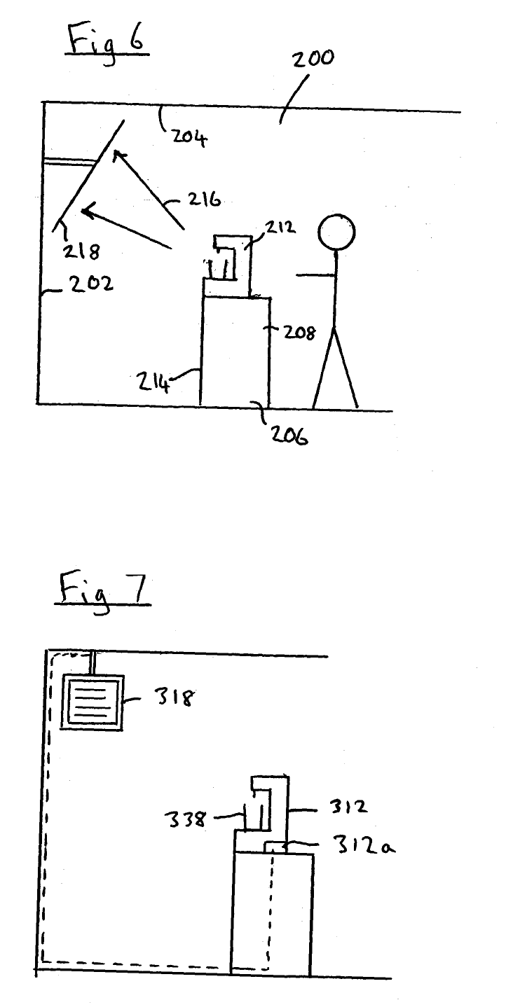

Referring to FIG. 5, in a fifth embodiment of the invention a font 112 comprises a rotating table 114 for supporting a glass and support arm 112 which arches over the platform 114 and supports the dispense nozzle 124. The platform is formed from a number of radially extending blades 114a and a circumferential ring 114b which between them define a number of apertures 114c through the platform. The platform 114 is supported on a vertical drive shaft 160. Around the drive shaft 160 a stationary light support ring 162 is provided which supports a number of lights 164 which direct light upwards towards the bottom of the platform 114. Any of the light that is not blocked by the platform passes through the apertures 114c to form a number of broad beams which shine upwards through the glass 138 and the beverage it contains. As the platform rotates these beams rotate also, forming a moving visual effect. Some of the beams will be directed onto the top of the support arm 112, and some will be directed past it. The platform 114 is rotated by means of a motor 115 controlled by a control unit 116 which also controls the dispense of beverage from the nozzle 124. In one mode of operation when the font 112 is activated to dispense a beverage the lights 164 are illuminated and the platform 114 rotated while the beverage is being dispensed. The rotation of the platform and illumination of the lights can be started at the beginning of the dispense cycle and stopped at the end of the dispense cycle. Alternatively they can be started at a predetermined point in the dispense cycle and continue for a predetermined time, which may be shorter than, or longer than, the dispense cycle.

Referring to FIG. 6, each of the fonts of FIGS. 2 to 5 is generally used in a bar, which will usually be a room 200 having walls 202 and a ceiling 204. The font 212 is mounted on a bar counter 206 having a front 208 at which a customer 210 stands to be served and a rear 214 where the bar staff will stand to serve the customers 210. If the font is arranged to produce beams of light 216 that are projected away form the font, these can be used in various ways to produce a visual effect which is visible to the customer 210 or to other potential customers in the bar.

The beams 216 themselves may be visible by virtue of the atmosphere in the room 200, which may either be naturally smoky or may have artificial ‘smoke’ provided in it. As the source of the beams rotates the beams themselves will be seen to rotate, which will produce a large scale visual effect above and around the bar 206.

Alternatively, or in addition, the beams 216 can be projected onto a surface, which may be one or more of the walls 202 or the ceiling 204 of the bar, or may be a screen 218 provided specifically for the purpose and positioned so as to be visible from a wide area within the bar. In this case the beams may be formed so as to provide information or a message to those who can see it.

Referring to FIG. 7, in a seventh embodiment of the invention the font 312 includes a control unit 312a which controls dispense of the beverage from the font into a drinking vessel 338, and also controls the display of images on a display screen 318. The beverage is dispensed in a dispense cycle, and the display starts when the dispense cycle starts and continues for a predetermined time, in this case until the beverage has been dispensed. Clearly the display could be started and stopped at any predetermined time in the dispense cycle, or indeed at predetermined times before or after it. The image displayed can be advertising or video footage of a sporting event or a great historic moment, or it can simply be an eye-catching visual display.

In a modification to this embodiment the font 312 is arranged to dispense a plurality of different beverages in a plurality of different volumes. The control unit 312 controls the selection of the beverage and the volume of beverage. The control unit 312 is also arranged to select one of a plurality of images for display on the screen 318, the selected image depending on which beverage and which volume of that beverage has been dispensed. The images may relate to the beverages, for example including advertising material, or be of a nature which corresponds to the type of beverage dispensed.

We claim:

1. A method of dispensing a beverage comprising providing a vessel, rotating the vessel, delivering beverage into the vessel at a point of dispense, and in response to dispense of the beverage, providing a visual display in the vicinity of the point of dispense.

2. A method according to claim 1 wherein the visual display is a moving display.

3. A method according to claim 2 wherein the visual display is a rotating display.

4. A method according to claim 3 wherein the vessel is rotated while the beverage is being dispensed.

5. A method according to claim 4 wherein the beverage is dispensed in a dispense cycle and the display is started at a predetermined point in the dispense cycle.

6. A method according to claim 5 wherein the visual display lasts a predetermined time.

7. A method according to claim 5 wherein the visual display ends at a predetermined time in the dispense cycle.

8. A method according to claim 1 including producing at least one moving beam of light to provide the visual display.

9. A method according to claim 8 including providing a light source having at least one moving part, projecting the beams of light from the moving part, and moving the moving part so as to provide the visual display.

10. A method according to claim 9 wherein said moving part is arranged to emit the beams of light.

11. A method according to claim 9 wherein the source is arranged to produce light and said moving part reflects the light to form the beams.

12. A method according to claim 9 wherein the source is arranged to produce light and the moving part comprises an obstacle past which at least some of the light is projected to form the beams.

13. A method according to claim 12 wherein the obstacle defines an aperture through which some of the light passes to form the beams.

14. A method according to claim 11 wherein said moving part comprises a moving member having a surface at least partly formed from a plurality of mirrors which produce a plurality of said light beams by reflection.

15. A method according to claim 14 in which said moving part is a mirror ball.

16. A method according to claim 9 wherein the vessel is rotated on a rotating support and said moving part is rotated by rotation of the support.

17. A method according to claim 16 wherein the moving part forms part of the support.

18. A method according to claim 16 wherein the moving part is mounted on the support.

19. A method according to claim 16 wherein the support has a surface on which the vessel is supported, and the moving part is situated on the surface so that the beams of light are transmitted through the vessel.

20. A method according to claim 16 wherein the moving part is mounted on the support at a position to one side of the vessel.

21. A method according to claim 16, in which the moving part is provided on a collar surrounding the vessel.

22. A method according to claim 21 wherein the collar is rotated as the beverage is dispensed.

23. A method according to claim 8 wherein the at least one beam of light is projected to provide the display.

24. A method according to claim 23 wherein the at least one beam of light is projected onto a surface to provide the visual display.

25. A method according to claim 24 including providing a screen having a surface which forms said surface.

26. A method according to claim 24 wherein the method is carried out in a room having a wall and a ceiling and at least one of the wall and the ceiling forms said surface.

27. A method according to claim 1 including providing a rotatable member associated with the vessel, the member bearing a succession of cinematographic representations and rotating the rotatable member to provide the visual display as an animated display.

28. A method according to claim 1, in which the vessel is a drinking glass.

29. A method according to claim 1 in which the beverage is alcoholic.

30. A method according to claim 29, in which the beverage is selected from the group consisting of beer and cider.

31. A method according to claim 30, in which the beverage is lager.

32. A method according to claim 1 comprising providing an enclosure having a window therethrough, and a rotatable member within the enclosure which has representations thereon, and rotating the rotatable member within the enclosure such that the representations are visible through the window to provide the visual display.

33. A method according to claim 1 wherein the display is controlled by a controller which also controls dispense of the beverage.

34. A method according to claim 1 wherein the display is provided on a video screen.

35. Apparatus for dispensing a beverage and providing a visual display, the apparatus comprising a support for a vessel, a dispense nozzle arranged to dispense beverage into the vessel, and a display arranged to provide a visual display in the vicinity of the rotating vessel in response to dispense of the beverage.

36. Apparatus according to claim 35 wherein the visual display is a moving display.

37. Apparatus according to claim 36 wherein the visual display is a rotating display.

38. Apparatus according to claim 37 wherein the vessel is rotated while the beverage is being dispensed.

39. Apparatus according to claim 35 wherein the beverage is dispensed in a dispense cycle and the visual display is arranged to start at a predetermined point in the dispense cycle.

40. Apparatus according to claim 35 wherein the visual display is arranged to last a predetermined time.

41. Apparatus according to claim 35 wherein the visual display is arranged to end at a predetermined time in the dispense cycle.

42. Apparatus according to claim 35 wherein the display is arranged to produce at least one beam of light to provide the visual display.

43. Apparatus according to claim 42 including a light source having at least one moving part, the moving part being arranged to project the beam of light so as to provide the visual display.

44. Apparatus according to claim 43 wherein said moving part is arranged to emit the beam of light.

45. Apparatus according to claim 43 wherein the source is arranged to produce light and said moving part is arranged to reflect the light to form the beams.

46. Apparatus according to claim 43 wherein the source is arranged to produce light and the moving part comprises an obstacle past which at least some of the light can be projected to form the beams.

47. Apparatus according to claim 43 wherein the obstacle defines an aperture through which some of the light can pass to form the beams.

48. Apparatus as claimed in claim 45 wherein said moving part comprises a moving member having a surface at least partly formed from a plurality of mirrors which produce a plurality of said light beams by reflection.

49. Apparatus method as claimed in claim 48 in which said moving part is a mirror ball.

50. Apparatus as claimed in claim 43 wherein said moving part is arranged to be rotated by rotation of the platform.

51. Apparatus according to claim 50 wherein the moving part forms part of the support.

52. Apparatus according to claim 50 wherein the moving part is mounted on the support.

53. Apparatus according to claim 52 wherein the support has a surface on which the vessel is supported, and the moving part is situated on the surface so that the beams of light are transmitted through the vessel.

54. Apparatus according to claim 52 wherein the moving part is mounted on the platform at a position to one side of the vessel.

55. Apparatus according to claim 54 further comprising a collar arranged to surround the vessel, wherein the moving part is provided on the collar.

56. Apparatus according to claim 55 wherein the collar is arranged to be rotated as the beverage is dispensed.

57. Apparatus as claimed in claim 42 further comprising a surface onto which the at least one beam of light can be projected.

58. Apparatus according to claim 57 including a screen which forms said surface.

59. Apparatus according to claim 57 including a room having a wall and a ceiling wherein at least one of the wall and the ceiling forms said surface.

60. Apparatus according to claim 35 including a rotatable member associated with the support, the member bearing a succession of cinematographic representations and being rotatable to provide said visual display as an animated display.

61. Apparatus according to claim 60 further comprising an enclosure surrounding the rotatable member and having a window therein through which the representations can be viewed.

62. Apparatus according to claim 35 further comprising control means arranged to control dispense of the beverage and the display.

63. Apparatus according to claim 62 wherein the display is a video screen.

64. Apparatus according to claim 35 which is arranged to be able to dispense any of a plurality of beverages, and to display any of a plurality of visual displays, wherein the visual display selected depends on the beverage selected.

65. A method according to claim 1 including selecting the beverage from a plurality of beverages and selecting the visual display from a plurality of visual displays depending on the selected beverage.
